(19) United States
(12) Patent Application Publication
(10) Pub. No.: US 2019/0204593 A1
(43) Pub. Date: Jul. 4, 2019

(54) OPTICAL DESIGN SYSTEMS AND METHODS FOR THE SAME

(71) Applicant: Lawrence Livermore National Security, LLC, Livermore, CA (US)

(72) Inventors: Brian J. Bauman, Livermore, CA (US); Michael D. Schneider, Danville, CA (US)

(21) Appl. No.: 15/860,609

(22) Filed: Jan. 2, 2018

(51) Int. Cl. G02B 27/00; G06F 17/50

(52) U.S. Cl. CPC G02B 27/0012; G06F 2217/16; G06F 17/5018

(57) ABSTRACT

Optical design systems perturb an optical design candidate to analyze the as-built performance of the optical design candidate. The optical design candidate can be perturbed by changing the values associated with tolerances and compensators. In an exemplary embodiment, the perturbations of the optical design candidate can include double Zernikes that allow the performance degradation of a perturbed optical design candidate to be calculated with a matrix multiplication using paraxial quantities rather than by iteration involving additional tracing of large set of rays.

### STATEMENT REGARDING FEDERALLY SPONSORED RESEARCH OR DEVELOPMENT

This invention was made with government support under Contract DE-AC52-07NA27344 awarded by U.S. Department of Energy. The government has certain rights in the invention.

### TECHNICAL FIELD

This patent document relates to systems, methods, and devices for facilitating design of optical systems.

### BACKGROUND

Optical design systems are used by scientist and engineers to design, test, and optimize a wide range of optical systems. For example, optical design systems can be used to design, test, and optimize the optical components installed in telescopes, binoculars, microscopes, movie projectors, and camera lenses.

The process of designing and tolerancing an optical system to achieve a desired optical performance can be complex. For instance, an optical designer may design an optical system by determining the number of components needed for the system, the type of glass used for the lenses, the surface profile of each optical surface, the radius of curvature of each optical surface, the glass thickness of each lens, the air gap between the lens, the tolerance for each optical component listed above, misalignment or wedge tolerances for each optical component listed above, and the like. Thus, it is desirable to simplify the process of designing and tolerancing, to optimize an optical system using an easier, faster, and better approach, and to design optical systems with a performance that is similar to the performance of an actual optical system as-built, rather than a mere theoretical and on-paper performance assessment.

### SUMMARY

A method of determining an optical system configuration is disclosed. The method comprises modifying a parameter associated with one of a shape, a position or a material of a first optical surface or optical component in an optical system that includes a plurality of optical surfaces or optical components, the optical system, prior to said modifying, having an associated nominal optical performance metric value, tracing a first set of rays through the optical system, (a) introducing a perturbation to the optical system to form a perturbed optical system, the perturbation representing a change in tolerance value associated with one of the optical surfaces or components of the optical system, (b) computing a revised optical performance metric value associated with the perturbed optical system, the revised optical performance metric value computed based on double Zernike polynomials or double Zernike coefficients and providing a measure of optical performance after propagation of the first set of rays through the plurality of optical surfaces or optical components of the perturbed optical system, (c) repeating operations (a) and (b) for a predetermined number of perturbations to collect a first set of revised optical performance metric values associated with a plurality of perturbations imparted to the optical system, and (d) determining from the first set of revised optical performance metric values and the nominal optical performance metric value a particular optical system configuration that produces an optical performance metric that meets or improves upon a particular optical performance characteristic.

In some embodiments, the particular optical performance characteristic corresponds to the system configuration that produces the lowest valued optical performance metric from the first set of revised optical performance metric values and the nominal optical performance metric value. In an embodiment, the computing the nominal or the revised optical performance metric values comprises: computing pupil Zernike coefficients and field Zernike coefficients of a wavefront at each optical surface or optical component of the optical system, and computing the nominal or the revised optical performance metric values based on a product of the pupil and field Zernike coefficients associated with the wavefront at each optical surface or optical component.

In some embodiments, the nominal optical performance metric value is computed based the following relationship:

MF₀²=ΣA_{nm,lk}²

wherein MF⁰ is the nominal optical performance metric value, and A_{nm,lk} are double Zernike coefficients; and wherein each of the revised optical performance metric values is computed based on the following relationship:

MF²=Σ(A_{nm,lk}+ΔA_{nm,lk})²

wherein MF is the revised optical performance metric value, A_{nm,lk} are double Zernike coefficients, and ΔA_{nm,lk}is a change in the double Zernike coefficients.

In some embodiments, the exemplary method further comprises adding one or more compensators into the optical system to compensate at least in-part for wavefront aberrations introduced by one or more of the optical surfaces or optical components, and determining the revised optical performance metric values for the optical system including the one or more compensators.

In an embodiment, the determining of the revised optical performance metric values comprises computing a residual value, Rᵢⱼ, that represents an effect of the one or more compensators on the optical system perturbed with a tolerance value, and computing each of the revised optical performance metric values as a compensated merit function based on the following relationship:

MF²=MF₀²+ΣRᵢⱼ²

wherein MF is the revised optical performance metric value, MF₀ is the nominal optical performance metric value, Rᵢⱼ is the residual value, index i is a residual double Zernike coefficient, and index j is the tolerance value.

In some embodiments, R is computed as:

R=T−Ĉ′Ĉ′^{T}T

wherein T is a tolerance column vector of the double Zernike coefficients, Ĉ′^{T} is a transpose of Ĉ′, and Ĉ′ is a set of orthogonal unit compensation vectors of a matrix comprising a number of Zernike polynomials by a number of orthogonal unit compensators.

In an embodiment, introducing a perturbation to the optical system includes introducing a change indicative of a tolerance value associated with the first optical surface or optical component.

In some embodiments, the double Zernike polynomials or double Zernike coefficients are computed based at least on the following operations: decentering the first optical surface or component by the tolerance value, perturbing a gut ray associated with the first optical surface or component and each additional optical surface or component that the perturbed gut ray passes through, and generating, for each optical surface or component that the perturbed gut ray passes through, a set of double Zernike polynomials or coefficients.

In an exemplary embodiment, computing each of the revised optical performance metric values comprises adding the set of double Zernike polynomials or coefficients.

In some embodiments, adding of the set of double Zernike polynomials or coefficients comprises a matrix multiplication to obtain a matrix comprising a number of Zernike polynomials by a number of tolerances.

In an embodiment, the exemplary method further comprises prior to operation (d), further modifying the parameter associated with one of a shape, a position or a material of the first optical surface or optical component, (e) introducing another perturbation to the optical system, (f) tracing a second set of rays through the optical system, (g) computing a revised optical performance metric value associated with the perturbed optical system subsequent to the perturbation, the revised optical performance metric value computed based on double Zernike polynomials or double Zernike coefficients and providing a measure of optical performance after propagation of the second set of rays through the plurality of optical surfaces or optical components of the perturbed optical system subsequent to the perturbation associated with the second of the plurality of optical surfaces or optical components, (h) repeating operations (e), (f) and (g) for a second predetermined number of perturbations to collect a second set of revised optical performance metric values, and wherein: operation (d) comprises determining from the first set of revised optical performance metric values, the second set of revised optical performance values and the nominal optical performance metric value the particular optical system configuration that produces the optical performance metric that meets or exceeds the particular optical performance characteristic.

In an exemplary embodiment, the method further comprises prior to operation (d), introducing additional perturbations to the optical system by changing parameters associated with one or more of shapes, positions or materials of the remaining optical surfaces or optical components in the optical system, computing additional set of sets of revised optical performance metric associated with additional perturbations, and wherein operation (d) comprises determining from nominal optical performance value, and the first and the additional sets of revised optical performance metric values, the particular optical system configuration that produces the optical performance metric that meets or exceeds the particular optical performance characteristic.

In some embodiments, the exemplary method further comprises selecting the particular optical system configuration that produces the optical performance metric that meets or exceeds the particular optical performance characteristic as the system configuration that produces lowest valued optical performance metric from the first set of revised optical performance metric values, the additional sets of revise optical performance metric values and the nominal optical performance metric value.

In an embodiment, the exemplary method further comprises prior to operation (c), restoring the perturbed optical system to the optical system prior to the introduction of the perturbation.

In some embodiments, the revised optical performance metric value that is computed based on double Zernike polynomials or double Zernike coefficients is obtained using two rays that are perturbed for the plurality of optical surfaces or optical components. In an embodiment, a first of the two rays is a gut ray, and the second of the two rays is one of a paraxial ray or a non-paraxial ray. In some embodiments, the revised optical performance metric value that is computed based on double Zernike polynomials or double Zernike coefficients is obtained without performing additional large-scale ray tracing operations. In some embodiments, the double Zernike polynomials or double Zernike coefficients include polynomials or coefficients associated with a chromatic aberration.

These general and specific aspects may be implemented using a system, a method or a computer program, or any combination of systems, methods, and computer programs.

These and other aspects and features are described in greater detail in the drawings, the description and the claims.

### BRIEF DESCRIPTION OF THE DRAWINGS

FIG. 1A shows a simple cemented triplet lens with four surfaces.

FIG. 1B shows a telescope with a misaligned secondary mirror.

FIG. 1C shows a design and tolerance process used by current optical design systems.

FIG. 1D shows that current design systems can theoretically include tolerancing and compensators analysis within the optimization process.

FIG. 2 shows an exemplary method that considers the action of tolerances and compensators in an analytic way.

FIG. 3 shows two graphs that show the conventions used to represent the pupil vector \vec{ρ} at the exit pupil plane of a lens; the field position vector \vec{H} located at the image plane; and the angle θ′ between vectors \vec{ρ} and \vec{H}, which is used in expressing Seidel aberrations.

FIG. 4 shows mathematical representation of Seidel aberrations in both the scalar and vector forms.

FIG. 5 shows the effect of the Nodal Aberration approach on the Seidel aberrations.

FIG. 6 shows an example of a simple design where the surfaces generate symmetric Seidel aberrations.

FIG. 7 shows an effect of a tilted surface on a gut ray.

FIG. 8 shows a truncated list of Double Zernike terms separated by pupil and field dependence.

FIG. 9 shows that double Zernikes can be thought of as geometrically forming a multidimensional vector space with one dimension per double Zernike.

FIG. 10A shows an exemplary process to determine the effect of a tolerance on an optical design.

FIGS. 10B-10C show an exemplary set of matrices used to determine the effect of a tolerance on an optical design.

FIG. 11 shows a block diagram of an exemplary system for determining an optical system configuration.

### DETAILED DESCRIPTION

In this patent document, the word “exemplary” is used to mean serving as an example, instance, or illustration. Any embodiment or design described herein as “exemplary” is not necessarily to be construed as preferred or advantageous over other embodiments or systems. Rather, use of the word exemplary is intended to present concepts in a concrete manner.

Optical design optimization can be a computationally-intensive process. Often, the optimization is aimed towards creating the best-performing nominal design. However, the optical performance is degraded when the optical components are assembled because the optics are not made perfectly nor assembled perfectly. This actual performance is referred to as as-built performance. During the design stage, the optical designer creates a set of fabrication and assembly tolerances that allow the lens to be built in a practical manner and yet does not unacceptably degrade the optical performance. This tolerancing process during the design stage is itself computationally-intensive.

Tolerances can often be eased so that lenses can be made more buildable. Tolerances can be eased by using compensators that allow for adjustments to the assembled optical system to improve performance. A simple example of a compensator is a focus knob on a telescope. A more complex example of a compensator is a sideways translation or a tilt of an optic. There can be multiple compensators as well. Assessing performance with tolerances in conjunction with compensators accurately characterizes the actual as-built performance of a designed optical system.

Each step of a design process can be intricate. As an example, the selection of the type of glass can involve selecting between multiple types of glass. The determination of the radii of curvature can be selected in a continuous range from approximately 1 millimeter to tens of meters. The choice of surface profile can include determining which surfaces should be aspheric and which should be spherical. The glass thickness for each lens can be selected in a continuous range from, for example, less than 1 millimeter to approximately 100 millimeters. The air gap between the lenses can be continuous from, for example, less than 1 millimeter to several millimeters, or even meters in some applications. Tolerance for each optical component describes the permissible variance in the physical dimension or property of an optical component.

When a design of an optical system yields a candidate design, that candidate is tested to determine its optical performance, typically by tracing many rays through the candidate optical system from selected field points and through selected points in the pupil. Each ray has a ray error in the image plane or an optical path difference (OPD). All the ray errors or OPDs are then combined to create a single number that describes performance, called a merit function (MF). In some cases, the best performance of the system can be determined by selecting parameters that produce the smallest MF. Thus, the smaller the merit function, the better the optical performance. The MF may also include other performance criteria, such as modulation transfer function (MTF), or constraints, such as focal lengths. In a design-optimization process, derivatives of the MF are calculated for all of the variables in the optical system to determine how to change the design.

Optical design systems use optimization algorithms to determine the most promising next candidate design with the smallest merit function. Optical design space is non-linear and with many local minima, so convergence is often slow and optimization routines may not find a global minimum, or even a good minimum. Run times for the optimization algorithms could be a few seconds for a simple lens to overnight or more for more complex systems. Furthermore, a poor choice for the initial system may not converge at all. Thus, while current optical design algorithms may find several candidate solutions identified with several local minima, global optimization is often needed to find better solutions. However, global optimization with current optical design systems can be an impractical task in part because it can be a lengthy operation lasting several hours to several weeks or longer for more complex optical designs.

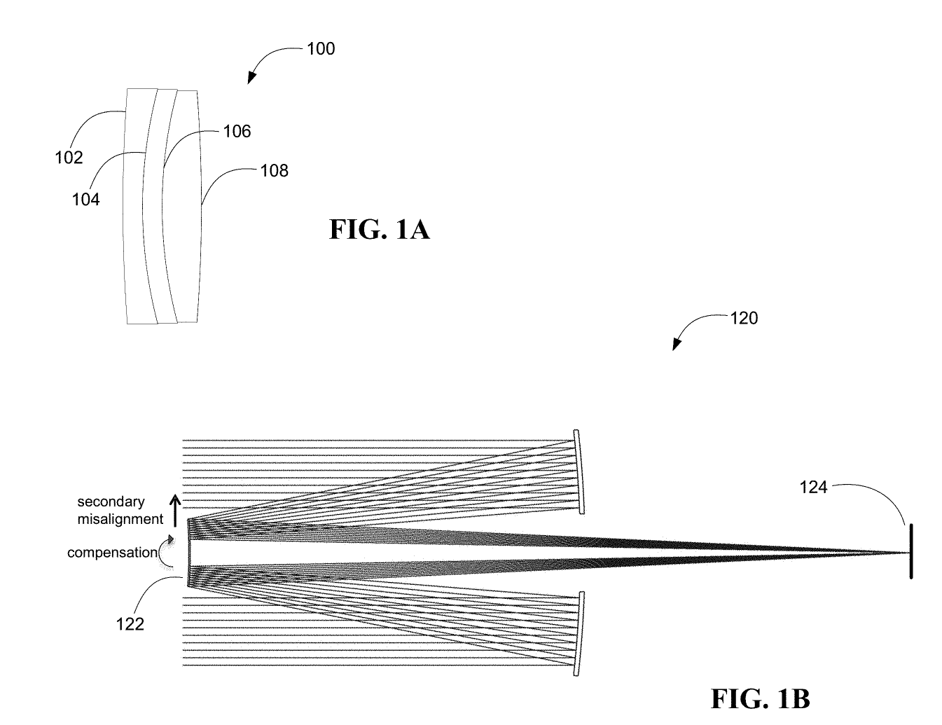

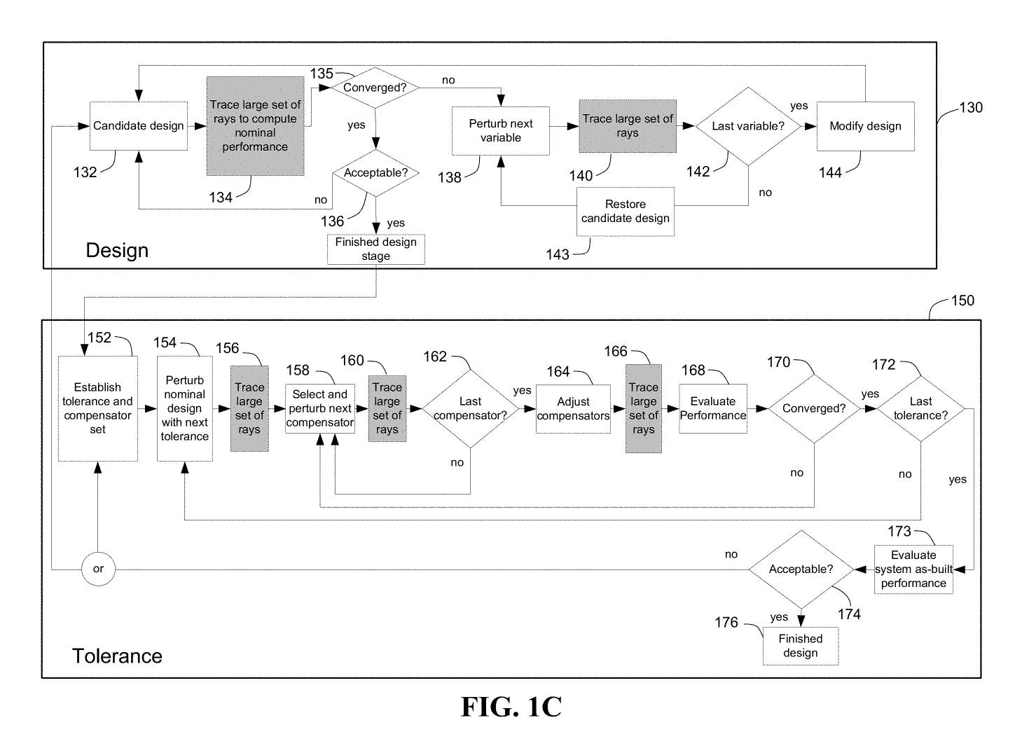

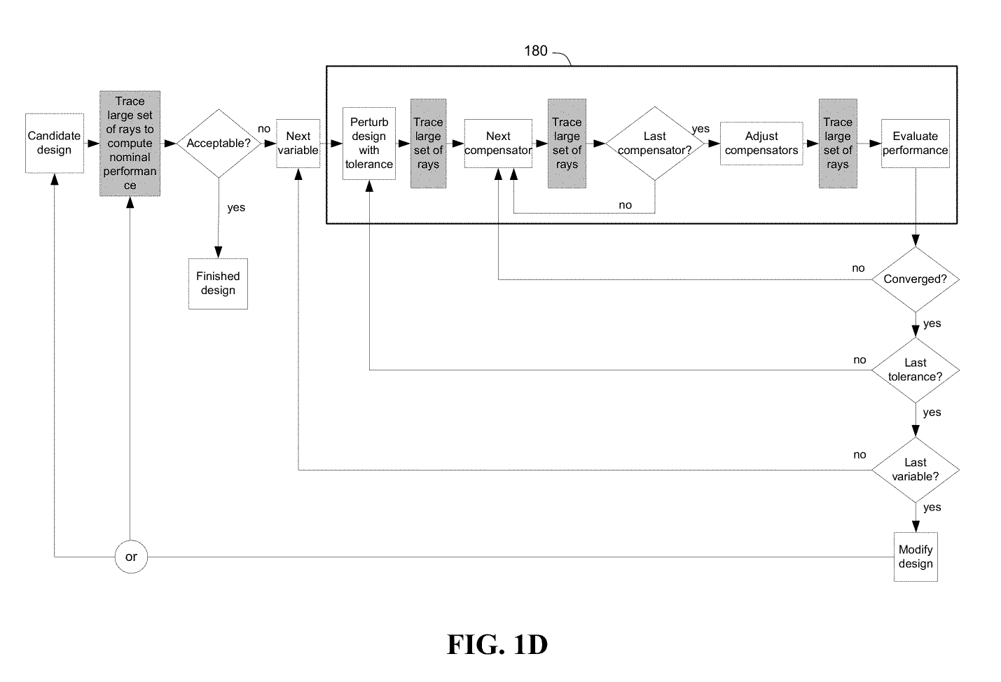

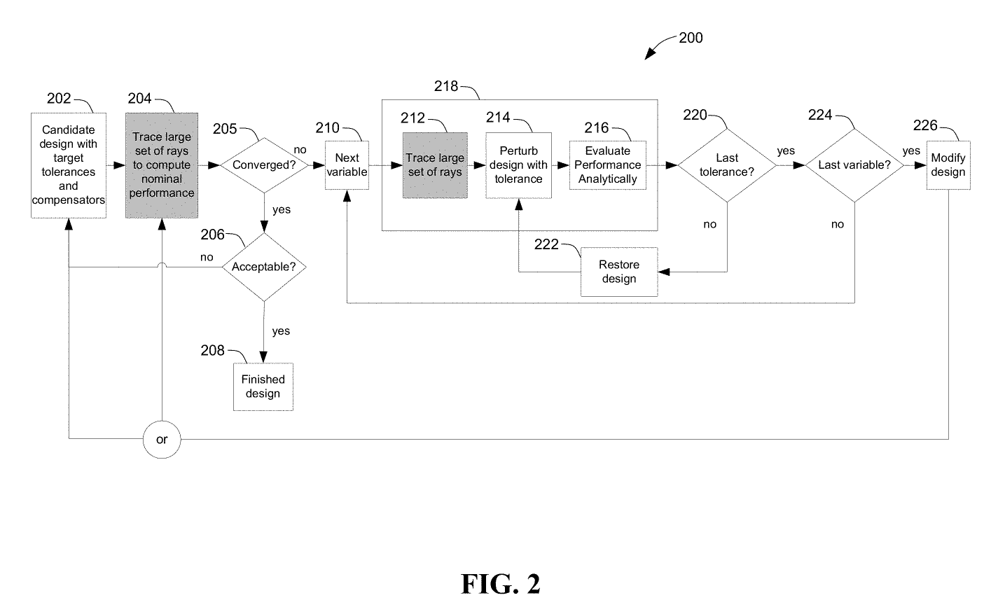

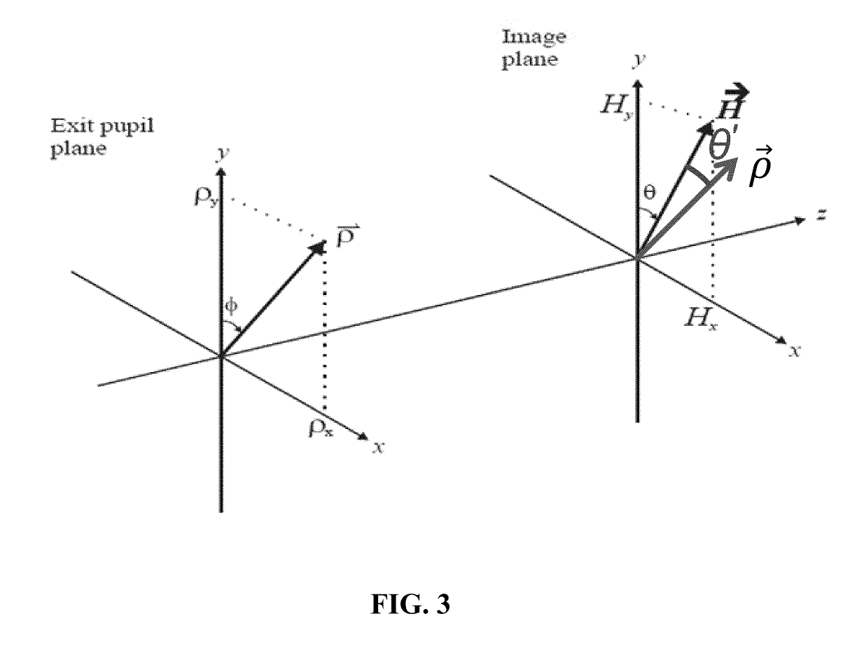

One difficulty in optimizing optical designs is that it is a numerically intensive process—this has been a longstanding problem in optical engineering. To illustrate this issue, it is instructive to assess the optical system of FIG. 1A, which shows a simple cemented triplet lens (100) with four surfaces ((102) through (108)). If a simple approach is used wherein one merely tries all the possible systems and then selects the best one, it can take many universe-ages to obtain an optimized design for the system of FIG. 1A, if all possible variables are tested. For example, suppose an engineer selects eight variables: four for radii of curvature and four for thicknesses, and suppose the engineer has only 1000 choices or design steps per variable. Assuming that each surface of the optical design of FIG. 1A is tested with efficient ray-selection techniques, for example, four field points, four wavelengths, and thirty-two rays in a four-ring Gaussian Quadrature pattern for each field point, then each candidate system requires 500 rays per system for this example. A set of rays, for example, the 500 rays per system that pass through an optical system, provides one example of a “large set of rays” shown in FIGS. 1C, 1D, and 2, and such rays can be used to characterize the performance of the optical system. With six surfaces per system, including object and image planes, this is 3000 ray-surfaces per candidate system. Moreover, since the system involves eight variables with 1000 design steps, the optical design algorithm needs to trace 10²⁴ systems * 3000 ray-surfaces/system, which equals 3×10²⁷ ray-surfaces. If a computer can compute approximately 100 million ray-surfaces/sec, the computation takes about 3×10¹⁹ seconds or 1×10¹² years. This computation time is six orders of magnitude larger than the annual computational power of the fastest supercomputer at many institutions or companies. Notably, these numbers correspond to a simple nominal design, without consideration of tolerancing.

FIG. 1B illustrates a Cassegrain telescope (120) with a misaligned secondary mirror (122). The misalignment of the secondary mirror (122) can result in a comatic aberration, also known as coma, at the image plane (124). The effects of coma can be partially compensated by tilting the secondary mirror. The amount of compensation can be determined with the traditional optimization algorithms that use an iterative approach that is not only computationally slow but also fails to use any insight into optical aberrations or optical performance for optimization.

Turning to the process of designing and tolerancing lenses, the design and tolerance activities are often separate for a conventional optical design system. FIG. 1C shows a design and tolerance process used by a typical optical design system. The process is broken up into two stages: Design (130) and Tolerancing (150). The design stage (130) starts by selecting a candidate optical system at step (132). The optical design system analyzes the candidate design by tracing large set of rays to compute nominal performance at step (134). Next, the optical design system determines whether the nominal performance has converged at step (135).

If the nominal performance has not converged at step (135), then the optimization design system assesses the merit function “terrain” around the current design. First, a design variable is chosen and adjusted to a new value at step (138). Design variables may be, for example, radii of curvature of each surface, glass thickness of each lens, or air gap between the lenses, and the operations at (138) can include either selection a new design variable or selecting a new value for the current variable to perturb the design. The design proceeds through a variable loop, steps (138)-(143), where one or more variables are chosen and adjusted or perturbed at step (138) and a large set of rays are traced at step (140) for each new design variation. The large set of rays is traced each time a different variable is chosen or adjusted after the candidate design is restored in step (143). The results of the iterative variable loop at steps (138)-(143) informs the optimizer of how to modify the current design to a new design at step (144) that is presented as a candidate design at step (132) to go through the same design steps.

If the nominal performance has converged at step (135) then a determination is made whether the nominal performance is acceptable at step (136). As an example, a nominal performance is acceptable if a calculated merit function for the design is below a predetermined value. If the nominal performance is acceptable, then the process moves to the tolerance stage (150). At the tolerance stage (150), the tolerance and compensator set are selected by a user at step (152), and the nominal design is perturbed with the tolerance selected by the user at step (154). A compensator adjusts one or more components of the optical design to obtain an image with minimum optical aberrations. One example of a compensator is a knob that can be used to bring an image into focus. Other examples compensators include a lens that can be shifted sideways in an assembly, a parallel plate, or a fabrication target of a component of the optical design. The optical design system traces a large set of rays for the design perturbed with the particular tolerance at step (156). For the design with the perturbed tolerance, the design proceeds through a compensation loop at steps (158)-(162) where one or more compensators are selected and perturbed at step (158) and a large set of rays are traced at step (160). The large set of rays is traced each time a different compensator is selected. The result of the compensation loop is then analyzed and the one or more compensators are adjusted at step (164). Subsequently, a large set of rays are traced at step (166) for the system with the perturbed tolerance and one or more adjusted compensators; the performance is evaluated at step (168). Next, the optical design system determines whether the performance has converged at step (170). If the merit function has not converged, then the first compensator is selected at step (158) and steps (160) (168) are repeated. If the merit function has converged, then the optical design system determines whether additional tolerances need to be evaluated for the candidate design at step (172). If additional tolerances need to be analyzed for the candidate design, the optical design software perturbs the candidate design with the next tolerance value and steps (156) to (172) are repeated. If all the tolerances are evaluated, the optical design software analyzes the results and the user evaluates the performance of the as-built candidate design at step (173). Subsequently, the user can determine whether the candidate design with the tolerance and compensation values is acceptable at step (174). At step (174), a user can compare the nominal merit function to the merit function with the tolerance and compensators in place. Each of the tolerances, after compensation, can have a performance penalty based on the merit function. The penalty is sometimes taken as MF-MF₀, and sometimes the penalty is in quadrature MF²-MF₀². All the tolerance performance penalties can be RSS'd together and added in quadrature to the nominal merit function to generate the expected as-built performance. A user may also evaluate using Monte Carlo (MC) approaches for the set of tolerances, then optimize the set of compensators for the perturbed system, and then repeat for many realizations for the tolerances. The various statistics resulting from a MC simulation can be generated, including mean performance, best, worst, or standard deviation. If the user determines that the candidate design is acceptable, then the process is finished at step (176). If the optical design system determines that the candidate design is not acceptable, then the user may select different tolerance and compensator sets at step (152) or select a different candidate design at step (132), and the above described steps are repeated.

Currently, commercial optical design packages such as Code V and Zemax do not have a way to efficiently implement tolerances and compensators into the optimization process. For example, Code V provides a generic constraint knob to reduce sensitivity of a tolerance, but a user must figure out the weighting of the tolerance. Moreover, Code V does not analyze the action of compensators that might entirely correct the tolerance in question. Thus, Code V can use sensitivity calculations to reduce the sensitivity of user-specified tolerances, but these do not consider the action of compensators, and do not provide a direct link to optical performance.

Code V's global approach is to find many candidates at local minima, then run tolerancing on all the candidate systems to determine which candidate has the best performance. However, the design with the best as-built performance may not be at a local minimum where the global approach can find it. Thus, the best nominal design may not have the best as-built performance. Thus, Code V's approach can easily miss solutions for which compensators very effectively handle tolerances, but which are not at local minima.

FIG. 1D shows that current design systems, such as Zemax can theoretically include tolerancing and compensators analysis (shown in box (180)) within the optimization process. To put in context, the tolerancing and compensators analysis (180) that could be theoretically implemented in Zemax in FIG. 1D would replace the computation performed by current systems in steps (140)-(144) and (152)-(168). However, the tolerancing and compensators analysis (180) is computationally impractical for optical designs other than the simplest designs because the algorithm is highly-nested with computationally-intensive ray-tracing in the innermost nested loop. Furthermore, the Zemax approach does not use any insight into optical aberrations or optical performance for optimization.

As illustrated above, conventional optical design optimization systems are computationally intensive. Indeed, among other shortcomings of such systems, conventional optical design optimization techniques determine nominal merit function of a candidate optical design, perturb one tolerance at a time for the candidate optical design, trace large set of rays after the design is perturbed with a tolerance, “optimize” the candidate optical design with one or more compensators until the rays converge, trace large set of rays each time a compensator is adjusted, determine the merit function, repeat the above steps for all tolerance values, and then determine an expected performance. Thus, an optical design optimization system is needed that minimizes iterative computations and that yields maximum expected as-built performance of an optical design considering realistic tolerances and actions of compensators.

FIG. 2 shows a set of operations (200) in accordance with an exemplary embodiment that incorporate the effects of tolerances and compensators in an analytic way and requires no large scale ray-tracing beyond that used for the nominal design. A typical ray-tracing operation, such as those shown at (134), (140), (150), (160) and (166) in FIG. 1C, involves tracing a large number of rays, for example, thousands or tens of thousands of rays for analyzing the optical characteristics of nominal designs. In accordance with the disclosed embodiments, instead of performing additional large-scale ray-tracing operations, the optical design system can trace a single paraxial ray for the system and one gut ray for each lens parameter that can be perturbed by tolerances or compensators. Such additional ray tracing operations that merely involve few rays are negligible when compared to thousands of rays used for performing a full additional ray-tracing. It should be noted that in some embodiments, additionally or alternatively to the use of a paraxial ray—which conforms to the small angle approximations and remains close to the optical axis throughout the system, one or more non-paraxial, “real” rays can be used to make the Seidel aberration computations that are carried through the optical system. It should be further noted that within the scope of the disclosed embodiments additional rays (e.g., 3, 4 or 10 rays) can be traced through the system for purposes of evaluating tolerances and compensators while still maintaining a low computational complexity. Thus, each design and analysis cycle of the disclosed exemplary method is nearly as fast as nominal design. The optimization processes can then directly optimize to mimic the performance of a system as-built.

The operations in FIG. 2 start by selecting a candidate design with target tolerances and compensators at step (202). At step (204), the optical design system traces a large set of rays to compute nominal performance. At step (205), the optical design system determines whether the nominal performance has converged. If the nominal performance has converged and the nominal performance is acceptable in step (206), then design is complete at step (208). As an example, a nominal performance is acceptable if a calculated merit function for the design is below a predetermined value. If the nominal performance is not acceptable in step (206), then the process returns to step (202).

If the nominal performance has not converged at step (205), then the optical design system proceeds to step (210) where a next design variable is chosen and adjusted to a new value. Design variables may be, for example, radii of curvature of each surface, glass thickness of each lens, air gap between the lenses, optical component material, or other parameters. Once a design variable is adjusted, a large set of rays are traced at step (212). As mentioned above, a large set of rays include thousands or tens of thousands of rays that are traced through the optical design with the adjusted variable.

Next, the optical design is perturbed with a tolerance at step (214). The performance of the optical design is evaluated by considering the effects of the perturbation using Seidel aberrations computed from a paraxial ray trace, equations from Nodal Aberration approach (to be described), and tracing of a single “gut” ray for each surface decenter axis. (212). In some embodiments, the evaluate performance analytically step (216) includes calculating the effect of the perturbations and including them in the merit function. The operations associated with evaluating the performance analytically at step (216), including the merit function calculations, are described in further detail in sections that follow. However, it is important to point out that the operations at step (218) replace large sections of the operations in FIGS. 1C and 1D (e.g., steps (140), and (152)-(170) of FIG. 1C and by the tolerancing and compensators analysis (180) of FIG. 1D), and notably the multiple and iterative ray tracing operations that are needed to be carried out in the conventional systems.

Referring back to FIG. 2, at step (220), the optical design system determines whether the applied perturbation corresponds to the last tolerance. If the optical design system determines at step (220) that the perturbation is not the final tolerance, the optical design system in step (222) restores the perturbed optical design to the nominal design. Next, the optical design system loops back to the step (214) and perturbs the nominal design with the next tolerance and evaluates performance without performing any additional ray tracing; this evaluation may include the effect of compensators, as will be described in this document. If the optical design system determines at step (220) that the last tolerance value was evaluated, then the optical design system proceeds to step (224) where a determination is made regarding whether additional variables need to be evaluated. It should be noted that in accordance with the above operations, a large number of perturbations can be applied to the system and evaluated analytically without a need for a full additional ray trace. As mentioned above, in one example, instead of performing a full additional ray-trace of thousands of rays, the optical design system traces a single paraxial ray for the system plus one gut ray for each lens parameter that can be perturbed by tolerances or compensators. As such, the system designer can select and evaluate the optical system, including the effects of tolerances and compensators, thus facilitating an optimized design for complex optical configurations.

In FIG. 2, if the optical design system determines at step (224) whether or not the final variable has been evaluated, and if not, then the optical design system loops back to step (210) where an additional variable is chosen for evaluation. Subsequently, the optical design system proceeds with the analysis performed in steps (212)-(220). If the optical design system determines at step (224) that the last design variable was evaluated, then the optical design system proceeds to step (226) where the candidate design can be modified and is then either presented to the designer at step (202) or is traced to determine nominal performance at step (204). The candidate design is modified based on the adjusted one or more design variables that yields the best performance. In some embodiments, the optical design system may use a graphical user interface (GUI) to present an option to a designer or an engineer whether to present the modified design or whether to trace large set of rays to compute nominal performance of the modified design.

There are several benefits of the exemplary method shown in FIG. 2. For example, an integrated optimization and tolerancing (IO&T) will lead to a faster optical design process. IO&T will allow the tolerancing to inform the design process, which is generally not possible with current design systems. Faster processing will mean that more of design space can be explored through global optimization to find solutions that could not otherwise be accessed. Finally, designers will have more confidence that optical design space has been analyzed to find optimal solutions.

In the following sections a brief introduction to various nomenclature and aberrations are provided to facilitate the understanding of system performance evaluation and determination of merit functions that follow.

Seidel Aberrations

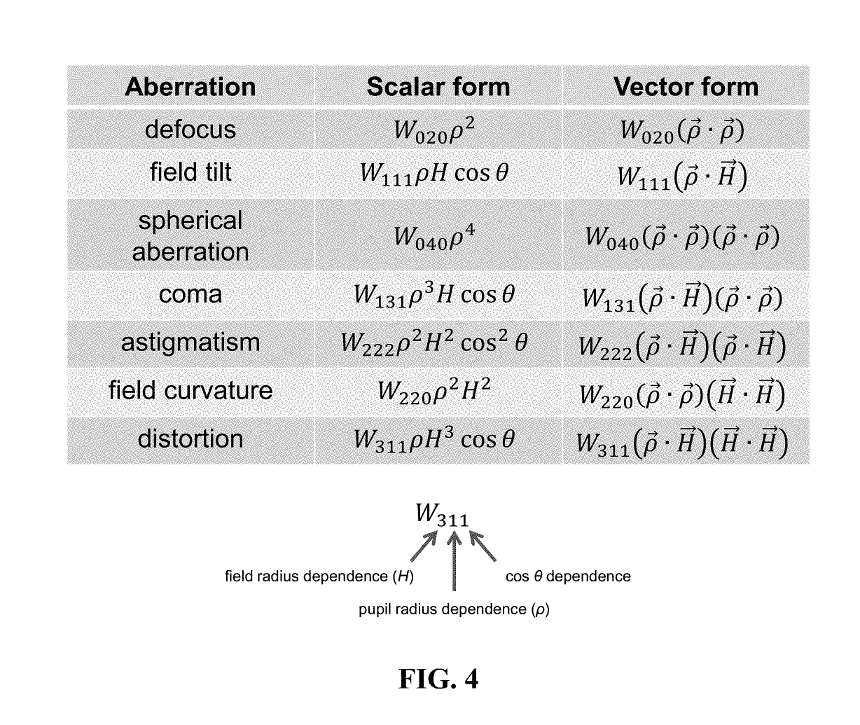

Optical aberrations describe the changes to the image quality due to imperfections in geometries and dimensions of optical components such as lenses and mirrors. Optical aberrations degrade image quality and can be described mathematically for optical systems as departures of the optical wavefront from a perfect spherical shape. Mathematically, aberrations from a single field point (\vec{H}) in the object plane are often expressed using polar coordinates using a wavefront distribution function W(ρ,θ), where ρ and θ are spherical coordinates of the as shown in FIG. 3, which shows the wavefront propagation from the exit pupil plane (e.g., a lens surface) to the image plane. ρ is the length of the vector \vec{ρ} and is usually normalized so that it equals 1. \vec{H} is the field height at the image plane. The angle between the vectors \vec{ρ} and \vec{H} is θ′.

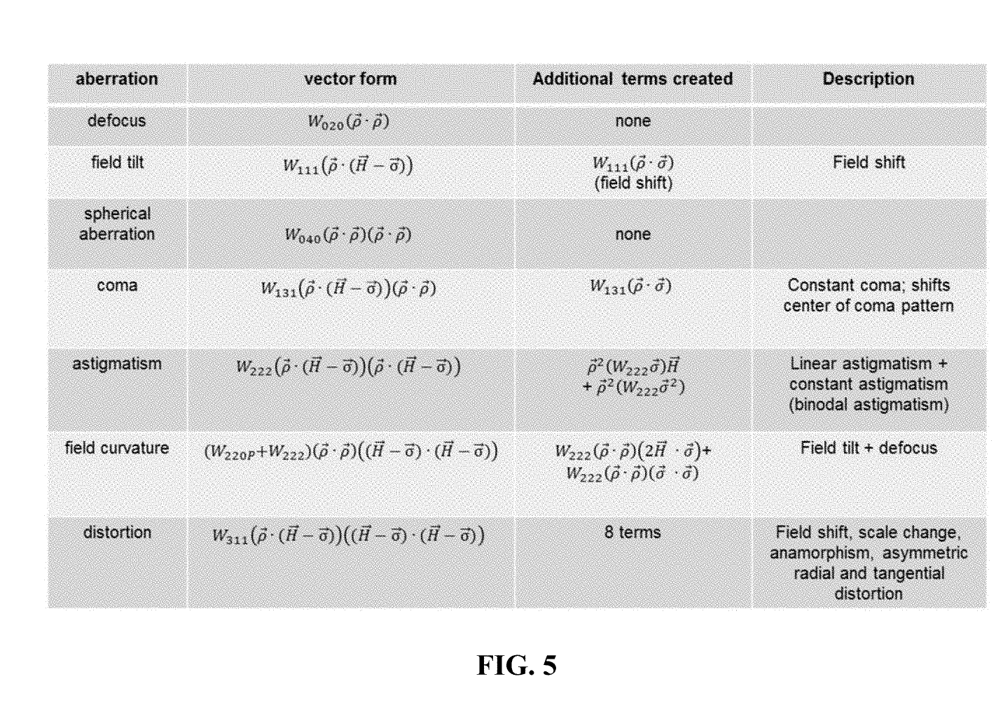

FIG. 4 shows mathematical representation of the Seidel aberrations in both the scalar and vector forms. The “W” coefficients are wavefront aberrations coefficients of the form originated by Hopkins and popularized by Shack. The coefficients are of the form Wᵢⱼₖ where i is the power of the radial field in the aberration term, j is the power of the radial pupil, and k is the power of the cosine of the angle between the field and pupil vector. A fourth index is sometimes used which refers to the surface that generated the aberrations in question. One type of aberration is known as spherical aberration. Spherical aberrations are independent of field H and are described using the following equation:

W(ρ)∝ρ⁴ Eq. (1)

Another type of aberration, known as a comatic aberration or coma, is described as follows:

W(ρ,θ)∝ρ³ cos θ Eq. (2)

The wavefront distribution function for coma is proportional to and linear with field (∝H)

Astigmatism is another type of optical aberration, and is represented as follows:

W(ρ,θ)∝ρ² cos² θ Eq. (3)

The wavefront distribution function for astigmatism is quadratic with field (∝H²).

Each surface in an optical system may contribute one or more types of aberration that add together to produce an aberrated image.

It should be noted that Seidel aberrations are not linearly independent from one another. Defocus, field tilt, spherical aberration, coma, astigmatism, Petzval curvature, and distortion are often considered the basic aberrations but these are actually poor choices in that they are not linearly independent. Double Zernike polynomials describe the same phenomena, but in a linearly independent way.

Perturbed Optical Systems—Aberrations of Asymmetric Optical Systems

Some of the disclosed embodiments rely on Nodal Aberration approach to facilitate the analysis and characterization of the perturbed optical systems. In the Nodal Aberration approach, aligned surfaces cause aberrations, such as coma and astigmatism that add or cancel in an intuitive scalar way. Misalignments from each surface cause that surface's aberrations to be shifted in the image plane, so that aberrations add in a more complex way. The shift in the surface's aberration field is found by tracing a gut ray. A gut ray, also known as an optical axis ray, is a ray that passes through the center of an aperture stop and the center of the field of view. In a centered system, the gut ray is coincident with the optical axis. For each misalignment a gut ray is traced to that surface's image space or to the system's image space to find out how much the aberration field is shifted. The shift in the surface's aberration field is described with a vector \vec{σ} which is normalized to equal 1 when the surface's aberration field is shifted by the maximum field height.

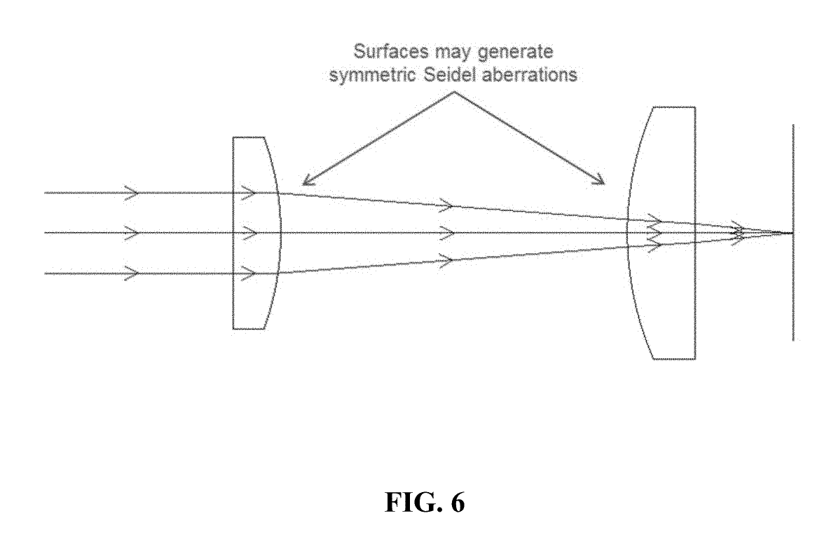

FIG. 5 illustrates the effect of the Nodal Aberration approach on the Seidel aberrations. This effect is illustrated by replacing \vec{H} in the aberration expressions above by (\vec{H}−\vec{σ}), where \vec{σ} is the normalized field displacement due to the surface's misalignment. This creates another set of aberrations as shown in FIG. 5 that are similar to the standard Seidel aberrations, but which have lower order in field dependence. These are referred to as decentered aberrations or asymmetric aberrations. Higher-order aberrations are not created.

It is often convenient to refer misalignments of a surface to its center of curvature. If the gut ray passes through the optical surface's center of curvature, then no asymmetric aberrations are generated; if the gut ray doesn't pass through the center of curvature, then asymmetric aberrations are generated.

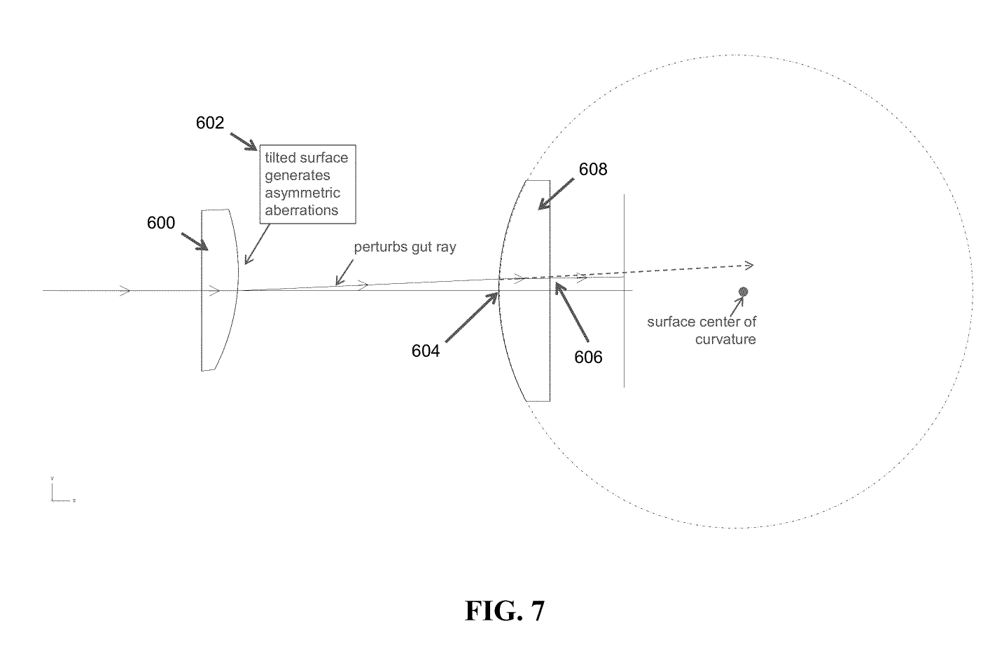

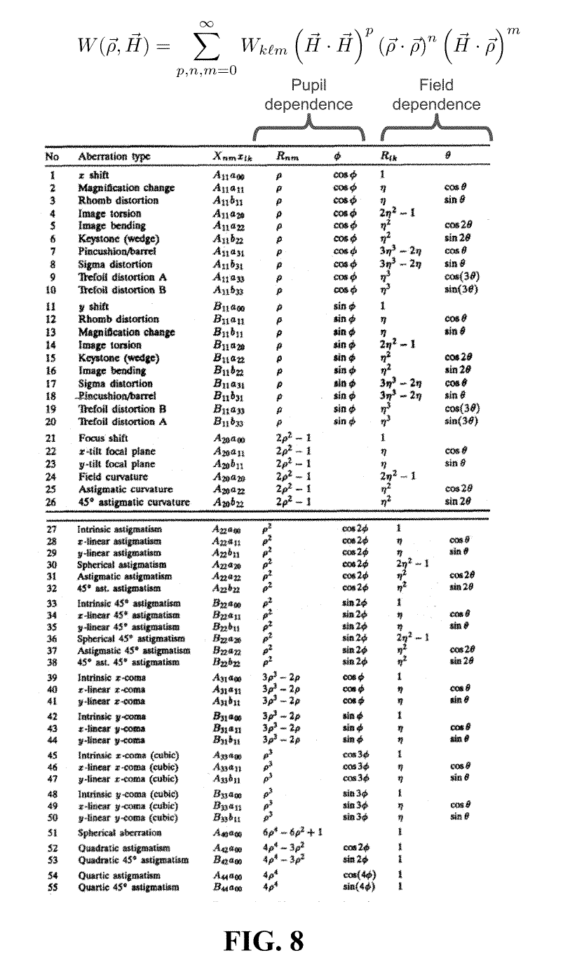

FIG. 6 shows an example of a simple design where the surfaces generate symmetric Seidel aberrations. FIG. 7 illustrates an effect of a tilted surface on a gut ray. For example, when a lens (600) is tilted, it also impacts all the other surfaces downstream of that lens, such as another lens (608), and introduces asymmetric aberrations from those other lenses that did not exist before. In some conventional systems, the perturbed optical system approach can be implemented for a simple lens with one surface, but the effect of a perturbation on a lens with downstream surfaces has been disregarded. Thus, some conventional systems employ an incomplete approach since they analyze only the asymmetric aberrations (602) generated by the tilted surface without considering the downstream effects. The exemplary method disclosed in FIG. 2 considers the downstream effects of, for example, a perturbed gut ray shown in FIG. 7. One downstream effect, shown at (604), includes asymmetric aberrations generated by a gut ray that is steered away from the center of the curvature. At (604), the symmetric Seidel terms remain unaffected. Another downstream effect, shown at (606), includes aberrations caused by the gut ray exiting the lens (608) at (606). The aberrations at (604) and (606) can be characterized by the aberration terms as shown in FIG. 5. In an exemplary embodiment, the aberration terms of both lenses (600) and (608) can be added together to obtain an accurately characterized perturbed optical system.

Appendix A in this patent document provides additional information regarding various system aberrations due to gut ray perturbation that can be expressed in terms of σ's.

Zernike Polynomials

Orthogonalization of aberrations is useful for analytic compensation. Zernike polynomials (Zₙₘ) are often used to describe wavefronts over a pupil, for a given field point, \vec{H}. The indices n and m indicate pupil dependencies, such as the power of the radial coordinate ρ and the power of the cosine or sine of the azimuthal angle θ. Zernike polynomials describe orthogonal set of polynomials over a circular domain where functions of pupil radial and azimuthal coordinates are described with Σ,θ. When Zernike polynomials are normalized so that their rms value over the pupil is unity, then they are denoted with a “hat”: \hat{Z} Zernike polynomials span the space of real functions over a circular pupil so that any practical wavefront can be constructed using Zernike polynomials shown below:

W(ρ,θ,\vec{H})=ΣAₙₘ\hat{Z}ₙₘ(ρ,θ) Eq. (4)

While Zernikes are usually defined over circular pupils, annular pupils have also been used. Through appropriate orthogonalization and calculation techniques, nearly any practical pupil could be represented in this way. Symmetry requires that Zernikes depend only on ρ² and the azimuthal angle.

Standard Zernikes have the very useful property that adding the coefficients in quadrature yields the variance of the wavefront error:

Wᵣₘₛ²(\vec{H})=ΣAₙₘ² Eq. (5)

In some embodiments, root mean square (RMS) and root sum square (RSS) are used interchangeably because RMS refers to the geometric mean, which is the square root of the sum of the squares.

Double Zernike Polynomials

The aberration function of an optical system is a function of four independent variables, in particular two pupil coordinates and two field coordinates. As discussed above, a wavefront's pupil dependencies with ρ,θ can be expressed with Zernikes. A wavefront's field dependencies with H,φ can be expressed with Zernikes as well. Multiplying pupil Zernikes by field Zernikes gives a double-Zernike basis set over the dual circular domains of pupil and field:

[symbol]

_{nm,lk}(\vec{ρ},\vec{H})≡\hat{Z}ₙₘ(\vec{ρ})\hat{Z}ₗₖ(\vec{H}) Eq. (6)

where indices l and k indicate field dependencies, and as mentioned above, indices n and m indicate pupil dependencies.

Double Zernikes form an orthogonal basis set and span the dual domain space (pupil, field) so that any system wavefront distribution can be expressed as a sum of double Zernike terms:

W_{sys}(\vec{ρ},\vec{H})=ΣA_{nm,lk} [symbol] _{nm,lk}(\vec{Σ},\vec{H}) Eq. (7)

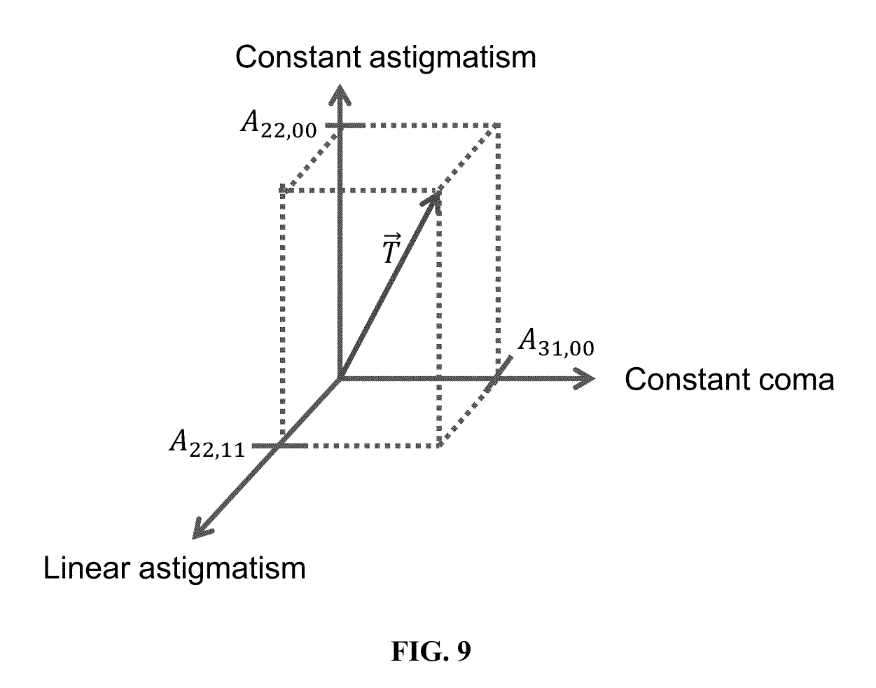

FIG. 8 shows a truncated list of Double Zernike terms separated by pupil and field dependence; the order of the Double Zernike terms is indefinite, as described in Kwee and Braat. While FIG. 8 shows a truncated list, in some of the disclosed embodiments, only a subset of the double Zernike's are used. In some embodiments, geometric distortion terms which change mapping but not image quality can be deleted. For example, rhomb distortion (numbers 3 and 12), image torsion (numbers 4 and 14), image bending (numbers 5 and 16), keystone (wedge) (numbers 6 and 15), and pincushion/barrel (numbers 7 and 18) can be deleted. In some embodiments, certain higher order terms, such as sigma distortion (numbers 8 and 17), intrinsic x-coma (cubic) (number 45), and quadratic astigmatism (number 52) can also be deleted.

The root mean square (RMS) wavefront error (WFE) for a single field point can be found by root-sum-squaring (RSS'ing) the pupil Zernike coefficients together:

Wᵣₘₛ²(\vec{H})=ΣAₙₘ² Eq. (8)

In some embodiments, a good measure of system performance is the RMS WFE, integrated and RSS'd over the whole field. This system performance can be found by RSS'ing the double Zernike terms together

W_{sys}²(\vec{H})=ΣA_{nm,lk}² Eq. (9)

In some embodiments, a merit function (MF) using a polynomial weighting on field is also calculated in addition, or in alternative, to calculating the RSS. These embodiments use the double Zernike coefficients A_{nm,lk}

Application of Double Zernikes to Tolerances

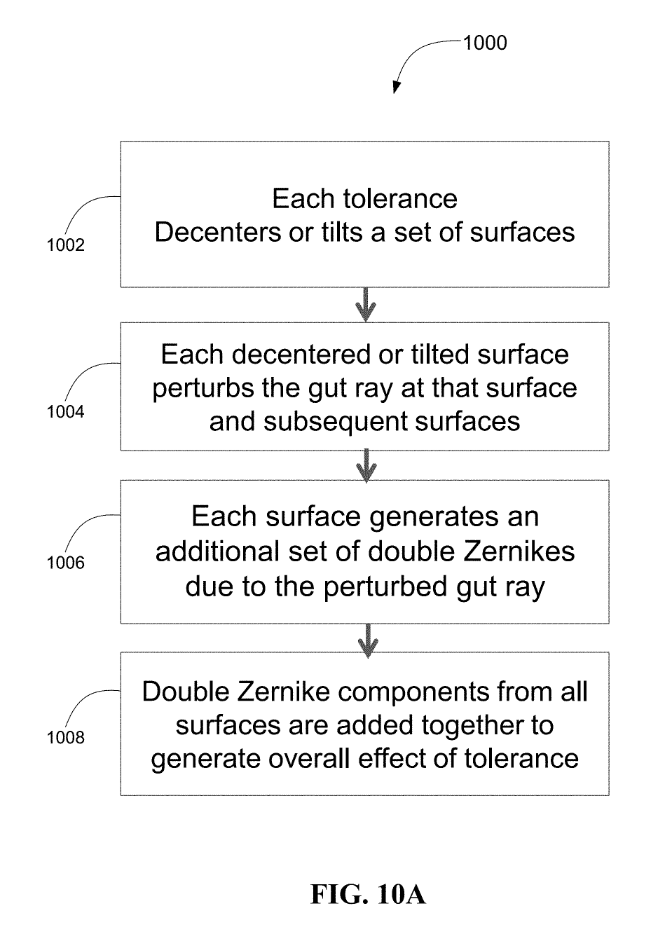

FIG. 9 shows that double Zernikes can be thought of as geometrically forming a multidimensional vector space with one dimension per Zernike. In some embodiments, a tolerance generates a vector \vec{T} with components equal to the double Zernike coefficients. Thus, \vec{T} can be represented by the following equation:

\vec{T}=ΣA_{nm,lk}\hat{Z}_{nm,lk} Eq. (10)

In an exemplary embodiment, the nominal system performance computed can be described as a sum of symmetric double Zernikes RSS'ed together for a single-number performance metric MF₀² where A_{nm,ik} are double Zernike coefficients.

MF₀²=ΣA_{nm,lk}² Eq. (11)

Tilt or decenter tolerances can be seen as generating additional double Zernike terms that are asymmetric, such as constant coma, and can be RSS'd into the nominal metric to evaluate performance. Tolerances in radii of curvature or thicknesses or distances change some of the existing symmetric double Zernike terms. These changes can also be incorporated into the single-number performance metric, as shown below. In some embodiments, the ΔA_{nm,lk}² term can be ignored.

MF²=Σ(A_{nm,lk}+ΔA_{nm,lk})² Eq. (12)

Unlike existing systems, the using the above merit function that is constructed as described above allows the exemplary process of FIG. 2 to be carried out for a large number of perturbations using a single set of ray tracing data. In essence, the effects of such perturbations are carried through mathematically through the appropriately formed merit function.

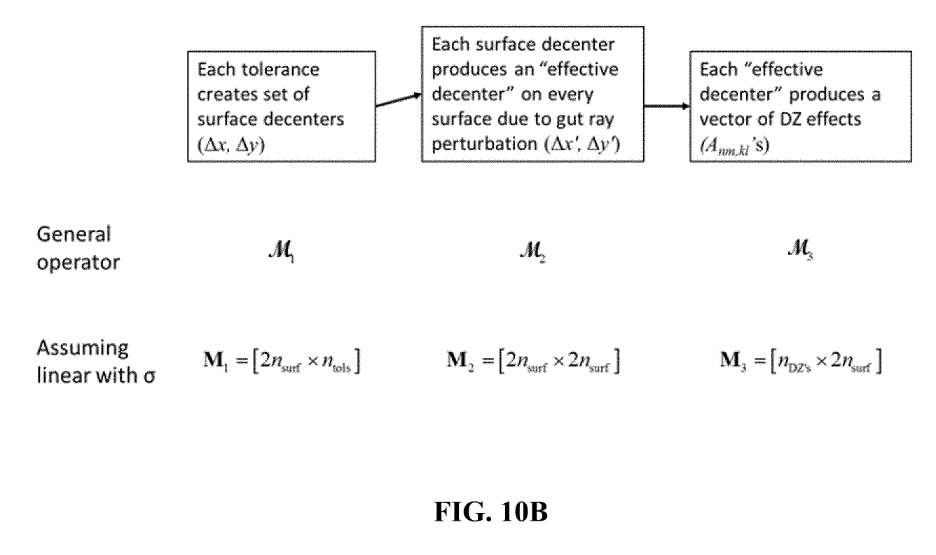

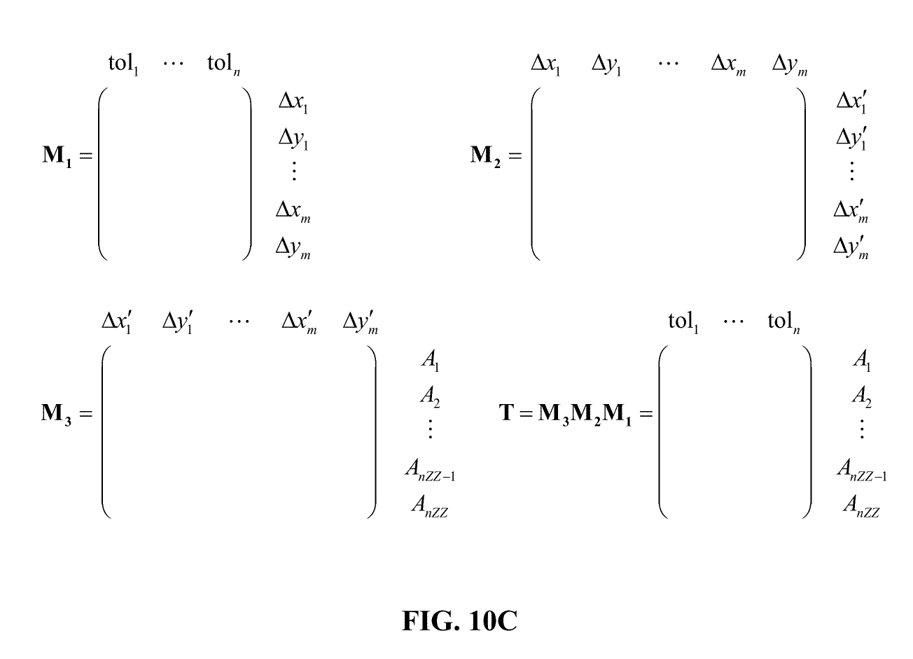

FIG. 10A shown an exemplary process (1000) to determine the effect of perturbing an optical system with a tolerance value. Each operation of the exemplary process (1000) can be described with an operator. In some embodiments, the operator can be represented by a matrix or a linear operator, especially for small tolerances. For example, at the decentering or tilting operation (1002), each tolerance decenters or tilts a set of surfaces. Thus, each tolerance can be described in terms of component surface decenters (Δx, Δy). The decentering or tilting operation (1002) can be described with a matrix or linear operator with the following dimensions:

M₁=2n_{surfaces}×n_{tolerance} Eq. (13)

where n_{surfaces} is the number of surfaces, and n_{tolerance} is the number of tolerances. The factor of 2 represents the transverse decenters Δx, Δy. In some embodiments, the factor may be different to allow for different kinds of tolerances such as tilt or change in distance, center thickness, or radius of curvature. For the case of a decentering tolerance, it can be considered as a linear combination of decenters in x and y of various surfaces. For example, a 100 micron decenter of a lens is composed of a 100 micron decenter of each of the two surfaces of the lens. Similarly tilts and decenter of lens groups can be similarly composed of surface decenters. The tolerance matrix, M₁, captures these tolerances.

At the perturbation operation (1004), each decentered or tilted surface perturbs, for example, the gut ray at that surface and subsequent surfaces. The gut ray perturbations at subsequent surfaces have the same effects on aberrations as though the surfaces were decentered. Each surface decenter can perturb the gut ray for all surfaces, which can be considered effective decenters (Δx′, Δy′) and a field-decentering parameter \vec{σ} is generated at each affected surface. The perturbation operation (1004) can be described with a following matrix or linear operator with the following dimensions:

M₂=2n_{surfaces}×2n_{surfaces} Eq. (14)

Matrix M₂ can capture the effective decenters that result from a unit perturbation of each surface. To find the elements of M₂, each surface is perturbed one at a time, and a gut ray is traced. Depending on the location of the aperture stop and which surface is perturbed, a given surface may see the gut ray perturbed by an amount (Δx′, Δy′); in general, each surface sees a different perturbation. The values in M₂ in that perturbed surface's column are the effective decenters for each surface, e.g., the displacements of the gut ray at each subsequent surface's center of curvature. This is applied to a unit value, which can be 1mm in some embodiments. In some other embodiments, this unit amount can be chosen differently as long as all the matrices use the same unit value.

At the double Zernikes (DZ) generation operation (1006), each surface generates an additional set of double Zernike polynomials due to the perturbed gut ray. In some embodiments, each surface's \vec{σ} can be used to calculate the resulting double Zernikes terms. The double Zernikes generation operation (1006) can be described with the following matrix or linear operator:

M₃=n_{Zernikes}×2n_{surfaces} Eq. (15)

where n_{Zernikes} is the number of double Zernike coefficients considered. The M₃ matrix takes a unit gut ray perturbation at a surface and finds the resulting double Zernikes coefficients, which are tabulated in a specific, consistent order.

At the addition operation (1008), the double Zernike components from all surfaces are added together to generate overall effect of tolerance. The addition operation (1008) can be described with the following matrix or linear operator where the matrix T yields double Zernikes resulting from each tolerance set:

T=M₁M₂M₃=n_{Zernikes}×n_{tolerance} Eq. (16)

Multiplying the matrices together yields the effect of an array of tolerances, as expressed in Equation 16.

FIGS. 10B and 10C show an exemplary set of matrices used to determine the effect of a tolerance on an optical design. In general, M₂ and M₃ depend nonlinearly on \dot{σ}, but if higher orders of \vec{σ} are excluded, the operators can be expressed in terms of matrices and use linear algebra. This approximation is often justified because tolerances tend to be small perturbations so that usually σ<<1. The term n_{DZ's} FIG. 10B and the term n_{ZZ} in FIG. 10C refer to double Zernike coefficients. In some embodiments, after calculating a residual performance using linear algebra, the size of the constant astigmatism term can be assessed, for example, in step (216) in FIG. 2, to see if the assumption of the constant astigmatism term being small was justified.

While the process of FIG. 10A discloses decenters of surfaces, such a process does not exclude considerations of centered tolerances such as lens spacing, center thickness, and radii of curvature tolerances. In some embodiments, the centered tolerances can be included into the tolerance matrix, M₁, and their effects into the double Zernikes matrix, M₃. The effect of these centered tolerances on other double Zernikes terms such as spherical aberration and field curvature can be calculated from the expressions for Seidel aberrations.

Analysis for Compensators

Compensators can be seen as having the same effects as tolerances, but are intentionally applied to cancel or compensate at least some the unwanted system aberration, and can thus be treated in a similar way as tolerances, although compensators are generally more limited in number. For example, in some embodiments, compensators are used to correct performance due to a tolerance in an optical design at step (214) of FIG. 2 and the effect of the compensation can be analyzed at step (216) of FIG. 2. In some embodiments, compensators can be vectors in a double Zernike space. In an exemplary embodiment, if one compensator and one tolerance are analyzed using the process of FIG. 2, the compensator is used to subtract out as much of the tolerance's double Zernikes to create the smallest residual. Mathematically, the residual R is described as:

R=\vec{T}−Ĉ(Ĉ·\vec{T}) Eq. (17)

where Ĉ(Ĉ·\vec{T}) is the projection of the unit compensator double Zernike vector onto the tolerance double Zernike vector, and the amount of compensation applied is Ĉ·\vec{T}.

The residual R can also be expressed with T and C as column vectors of double Zernike coefficients:

R=T−ĈĈ^{T}T Eq. (18)

where Ĉ^{T} is a transpose of Ĉ, Ĉ is a set of orthogonal unit compensation vectors of C, and Ĉ^{T}T is the dot product of Ĉ·\vec{T}. For example, Ĉ for one compensator may describe the effect of a unit compensator motions, such as a millimeter's worth of defocus, on the double Zernike coefficients. In some embodiments where multiple compensators are used in the optical design, the Ĉ will have different columns populated with changes to the double Zernike coefficients. In some embodiments, vector Ĉ can be determined in the same manner as described in the exemplary process and matrices of FIGS. 10A-10C to obtain matrix T. For example, the compensator matrix can be given by:

$$\hat{C} = {M}_{3} {M}_{2} {M}_{1}^{′} \\ {comp}_{1} ⋯ {comp}_{n} \\ {M}_{1}^{′} = ( \text{?} ) \begin{matrix}Δ {x}_{1} \\ Δ {y}_{1} \\ ⋮ \\ Δ {x}_{m} \\ Δ {y}_{m}\end{matrix} \\ \text{?} \text{indicates text missing or illegible when filed} \qquad Eq . ( 19 )$$

where a new matrix M₁′ can be used which defines the unit compensators. The elements of the matrices M₂ and M₃ are the same as described above since the effects of compensators are identical to tolerances.

In another exemplary embodiment, if multiple compensators n_{compensato r} are analyzed by the exemplary method of FIG. 2, an orthonormal set of compensators, \vec{C}′ are formed from the original set \vec{C} via a Gram-Schmidt process or numerically, a modified Gram-Schmidt process. In this way, the overlapping effects of the compensators due to their linear dependence can be mitigated.

If the double Zernike effects of the tolerances , T, and the double Zernike effects of the orthogonalized compensators C′ are formed as matrices, viz.,

T: n_{Zernikes}×n_{tolerance} Eq. (20)

C′:n_{Zernikes}×n_{compensato r} Eq. (21)

where number of tolerances is n_{tolerance} and the number of orthogonal unit compensators is n_{compensato r}.

Then, the matrix of double Zernike residuals R after correcting the tolerances T by compensators C′ is given by

$$R = T - {C}^{′} {C}^{′ T} T \\ {tol}_{1} ⋯ {tol}_{n} \\ {M}_{1}^{′} = ( \text{?} ) \begin{matrix}{A}_{1} \\ {A}_{2} \\ ⋮ \\ {A}_{nZZ - 1} \\ {A}_{nZZ}\end{matrix} \\ \text{?} \text{indicates text missing or illegible when filed} \qquad Eq . ( 22 )$$

Each column represents the residual double Zernikes from the corresponding tolerance. Thus, R=n_{Zernikes}×n_{tolerances}.

Expected Degradation Due to Tolerances

If the values used in T represent the standard deviations of the tolerances, then in an exemplary embodiment, the elements of R can be RSS'd together to form the standard deviation of the degradation expected by the set of tolerances:

ΔW²=ΣRᵢⱼ² Eq. (23)

where the summation is performed over a residual double Zernike coefficients, i, and the tolerances, j. Note that an equivalent expression can be obtained from Equations (11) and (12). In some embodiments, this value can be RSS'd with the merit function of the nominal design to form the performance metric of the toleranced system. This can be done analytically without any additional ray tracing.

MF²=MF₀²+ΣRᵢⱼ² Eq. (24)

Once again, one of the benefits of the above described techniques is that a candidate optical system can be analyzed and optimized (including determining tolerances and compensators), without requiring several iterations of ray-tracing operations. As such, design and optimization of complex as-built optical systems is made possible.

Chromatic Aberrations—Axial Color

Axial color is a wavelength-dependent defocus (picture) and does not depend on field position; the only tolerances that affect axial color are radii of curvature and distances/thicknesses. Thus, for axial color, the same analysis can be performed as spherical aberration. In some embodiments, tilts or decenters are handled the same way for axial color as they are for spherical aberration—there is no change for tilts or decenters.

Chromatic Aberrations—Lateral Color

Lateral color is wavelength-dependent magnification. Lateral color presents as a transverse smearing of color into a spectrum away from the center of the field. Lateral color is linear with field. Thus, for lateral color, the same analysis can be performed as coma. In some embodiments, tilts or decenters are handled the same way for lateral color as they are for coma and there is an equivalent Seidel term for lateral color. Appendix B in this patent document provides additional information regarding expansions to additional double Zernike terms that can be used for representing axial and lateral color.

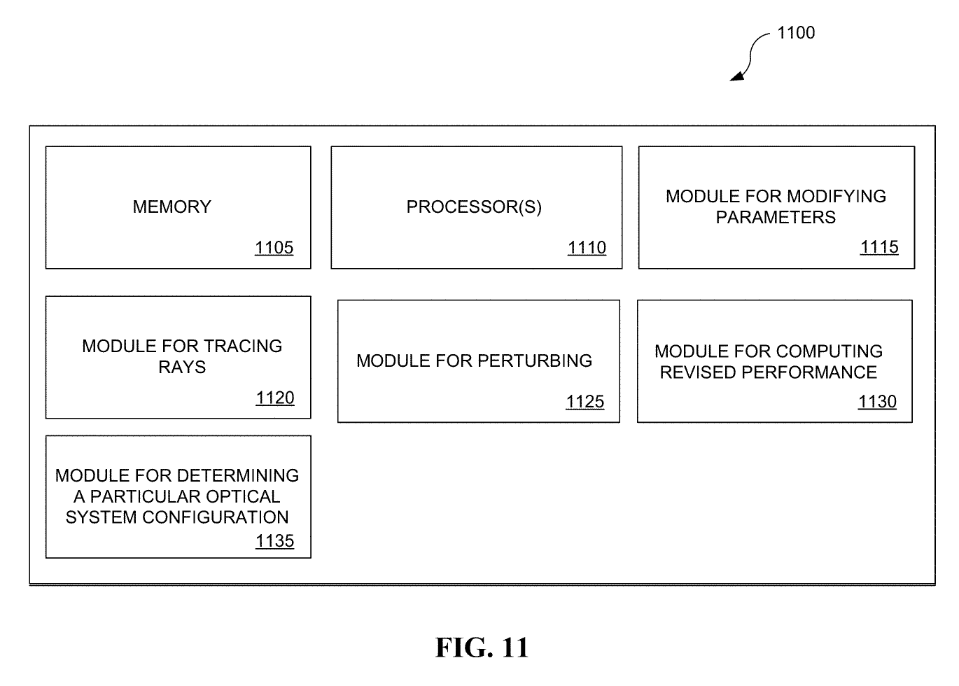

FIG. 11 shows a block diagram of an exemplary device (1100). The exemplary device comprises a memory (1105) and one or more processors (1110). The memory (1105) includes processor-executable instructions stored thereon. The processor-executable instructions upon execution by the one or more processors configure the device according to the various modules and features described in this document. In an exemplary embodiment, the device (1100) may be one or more computers or one or more servers. In some embodiments, the various modules associated with the device (1100) may be located on the same computer or server or they may be located on different computers or servers.

A module for modifying parameters (1115) can modify a parameter associated with one of a shape, a position or a material of a first optical surface or optical component in an optical system that includes a plurality of optical surfaces or optical components, the optical system, prior to said modifying, having an associated nominal optical performance metric value. The module for tracing rays (1120) can trace a first set of rays through the optical system.

The module for perturbing (1125) can introduce a perturbation to the optical system to form a perturbed optical system, the perturbation representing a change in tolerance value associated with one of the optical surfaces or components of the optical system. Module for computing revised performance (1130) computes, without performing additional ray tracing operations, a revised optical performance metric value associated with the perturbed optical system, the revised optical performance metric value computed based on double Zernike polynomials or double Zernike coefficients and providing a measure of optical performance after propagation of the first set of rays through the plurality of optical surfaces or optical components of the perturbed optical system.

The operations associated with the module for perturbing (1125) and the module for computing revised performance (1130) can be repeated for a predetermined number of perturbations to collect a first set of revised optical performance metric values associated with a plurality of perturbations imparted to the optical system. The module for determining a particular optical system configuration (1135) can determine from the first set of revised optical performance metric values and the nominal optical performance metric value a particular optical system configuration that produces an optical performance metric that meets or improves upon a particular optical performance characteristic.

In some embodiments, a computer program product comprising a non-transitory computer-readable medium having a program code stored thereon that is executable by a processor. The program code includes, for example, the features associated with the various modules of FIG. 11.

Appendix A—Examples of Decentered System Aberrations Expressed in Terms of Double Zernikes

Spherical Aberration

Since spherical aberration does not depend on field, there are no additional terms created by decentering a surface with spherical aberration.

Constant Coma

Constant coma can be expressed by:

$$\begin{matrix}W = {W}_{131 j} ( \vec{ρ} \cdot \vec{ρ} ) ( \vec{ρ} \cdot \vec{{σ}_{j}} ) \\ = {W}_{131 j} ( {σ}_{xj} {ρ}^{3} cos θ + {σ}_{yj} {ρ}^{3} sin θ ) \\ = \frac{{W}_{131 j} {σ}_{xj}}{\sqrt{72}} {\hat{Z}}_{00 , 31} + \frac{{W}_{131 j} {σ}_{yj}}{\sqrt{72}} {\hat{Z}}_{00 , - 31}\end{matrix} \qquad Eq . ( 25 )$$

Linear Astigmatism

In an analogous way, linear astigmatism can be expressed by:

W=W₂₂₂ⱼ(\vec{Hσ}ⱼ)·ρ² Eq. (26)

Now,

$$\begin{matrix}( \vec{H } \vec{{σ}_{j}} ) \cdot \vec{{ρ}^{2}} = ( {H}_{x} {σ}_{x} - {H}_{y} {σ}_{y} , {H}_{y} {σ}_{x} - {H}_{x} {σ}_{y} ) \cdot \\ ( {ρ}^{2} {cos}^{2} θ , {ρ}^{2} {sin}^{2} θ ) \\ = \begin{matrix}H {ρ}^{2} ( {σ}_{x} cos 2 θ cos φ - {σ}_{y} cos 2 θ sin φ + \\ {σ}_{x} sin 2 θsin φ - {σ}_{y} sin 2 θ cos φ )\end{matrix}\end{matrix} \qquad Eq . ( 27 )$$

Therefore,

$$W = - \frac{{W}_{222 j}}{\sqrt{24}} ( {σ}_{x} {\hat{Z}}_{11 , 22} - {σ}_{y} {Z}_{- 11 , 22} + {σ}_{x} {Z}_{- 11 , - 22} - {σ}_{y} {Z}_{11 , - 22} ) \qquad Eq . ( 28 )$$

Constant Astigmatism

Using the same approach, constant astigmatism can be expressed by:

$$\begin{matrix}W = \frac{1}{2} {W}_{222 j} ( {\vec{{σ}_{j}}}^{2} \cdot {\vec{ρ}}^{2} ) \\ = \frac{1}{2} {W}_{222 j} ( {σ}_{xj}^{2} - {σ}_{yj}^{2} , 2 {σ}_{x} {σ}_{y} ) \cdot ( {ρ}^{2} {cos}^{2} θ , {ρ}^{2} {sin}^{2} θ ) \\ = \frac{1}{2} {W}_{222 j} [ ( {σ}_{xj}^{2} - {σ}_{yj}^{2} ) {ρ}^{2} {cos}^{2} θ + 2 {σ}_{x} {σ}_{y} {ρ}^{2} {sin}^{2} θ ] \\ = {W}_{222 j} \frac{( {σ}_{xj}^{2} - {σ}_{yj}^{2} )}{\sqrt{24}} {\hat{Z}}_{00 , 22} + {W}_{222 j} \frac{{σ}_{x} {σ}_{y}}{\sqrt{6}} {\hat{Z}}_{00 , - 22}\end{matrix} \qquad Eq . ( 29 )$$

Field Tilt

Field tilt can be expressed by:

$$\begin{matrix}W = - 2 {W}_{222 j} ( \vec{H} \cdot \vec{{σ}_{j}} ) ( \vec{ρ} \cdot \vec{ρ} ) \\ = - {W}_{222 j} [ {σ}_{x} H cos φ + {σ}_{y} H sin φ ] [ ( 2 {ρ}^{2} - 1 ) + 1 ] \\ = - \frac{{W}_{222 j}}{\sqrt{24}} {Z}_{11 , 20} - \frac{{W}_{222 j}}{\sqrt{24}} {Z}_{- 11 , 20} + piston terms\end{matrix} \qquad Eq . ( 30 )$$

Defocus

Defocus can be expressed by:

$$\begin{matrix}W = {W}_{222 j} ( \vec{{σ}_{j}} \cdot \vec{{σ}_{j}} ) ( \vec{ρ} \cdot \vec{ρ} ) \\ = {W}_{222 j} ( {σ}_{jx}^{2} + {σ}_{jy}^{2} ) [ ( 2 {ρ}^{2} - 1 ) + 1 ] \\ = \frac{{W}_{222 j} ( {σ}_{jx}^{2} + {σ}_{jy}^{2} )}{\sqrt{3}} {\hat{Z}}_{00 , 20} + piston terms\end{matrix} \qquad Eq . ( 31 )$$

Lateral Color

Since the field dependence is identical to that of coma, the expression for the decentered aberrations is the same except for the coefficient:

$$\begin{matrix}W = {W}_{111 λ j} ( \vec{ρ} \cdot \vec{ρ} ) ( \vec{ρ} \cdot \vec{{σ}_{j}} ) \\ = {W}_{111 j} ( {σ}_{xj} {ρ}^{3} cos θ + {σ}_{yj} {ρ}^{3} sin θ ) \\ = \frac{{W}_{111 λ j} {σ}_{xj}}{\sqrt{72}} {\hat{Z}}_{31 , 00} + \frac{{W}_{111 λ j} {σ}_{yj}}{\sqrt{72}} {\hat{Z}}_{- 31 , 00}\end{matrix} \qquad Eq . ( 32 )$$

where

$${W}_{111 λ j} = y ( n \overline{i} ) ( \frac{Δ {n}^{′}}{{n}^{′}} - \frac{Δ n}{n} ) \\ y = marginal ray height at surface j \\ n , {n}^{′} = refractive index in optical space before \text{/} after \\ surface j \\ Δ n , Δ {n}^{′} = change of index due to dispersion in \\ optical space before \text{/} after surface j \\ \overline{i} = angle of incidence of chief ray at surface j \qquad Eq . ( 33 )$$

These terms can be rss'd with the nominal design to obtain the performance with perturbations.

Appendix B—Representing Additional Double Zernike Terms

Some embodiments further disclose a technique to optimize as-built performance of an optical system under a set of assumptions: (1) the merit function is the RMS wavefront error rss'd across the field; (2) induced aberrations are excluded; (3) aberrations higher than 4th order are also excluded. Having developed the type of technique, this section shows that these assumptions are not necessary. In general, the disclosed embodiments can operate based on at least three ingredients: 1) formulas for the centered aberrations (e.g., W₁₃₁, W₂₂₂) up to the desired order; 2) Nodal Aberration approach (or equivalent) that includes the contemplated extension, including formulas to calculate the decentered aberrations; 3) an orthonormal basis set, such as Double Zernike that can express the system aberrations and which can be rss'd into a single system performance metric.

Higher-Order Aberrations

The approach disclosed above can use 4th order centered and decentered aberrations. Intrinsic (as opposed to induced/extrinsic) higher-order aberrations can be handled the same way. In some embodiments, the disclosed techniques can be extended to 6th-order aberrations. The double Zernike polynomial set includes arbitrarily-high order terms and so it does not impose a limitation. Formulas for 6th order aberrations have been developed as well as 6th order Nodal Aberration approach, thus all three ingredients as described above exist. In some embodiments, arbitrarily high orders can be in included in this technique as long as the required formulas for aberration contributions can be found and the required Nodal Aberration approach results can be generated.

Sixth-order Nodal Aberration approach can generate several more decentered aberrations that are linear in σ, as well as several others that are higher-order in σ. Again, as long as σ<<1, the high-order terms can be excluded in order to use matrices; otherwise, higher-order programming may be used.

RMS Spot Size or Other Image Quality Metrics

RMS spot size rather than RMS wavefront error can be used as a metric for a single field point's image quality. The RMS wavefront error can be found by using an orthonormal basis set to describe the wavefront, e.g., standard Zernike polynomials. The RMS wavefront error was then the RSS of the standard Zernike coefficients (Equation 5). An orthonormal basis set for vector polynomials on the unit circle can be developed; these can be derived from the gradients of the standard Zernike polynomials. Using these vector Zernikes, the ray error function can be expressed ad:

$$\vec{ɛ} ( ρ , θ ) = {\sum }_{m , n} {A}_{nm} {S}_{nm} ( ρ , θ ) \\ where \\ \vec{ɛ} ( ρ , θ ) = vector ray error at image plane from ray with pupil coordinates ( ρ , θ ) \\ {\vec{S}}_{nm} ( ρ , θ ) = orthonormal vector polynomials defined in Zhao and Burge \qquad Eq . ( 34 )$$

A new double Zernike polynomial can be created which is the product of the orthonormal terms in pupil and field:

\vec{S}_{nm,ki}(\vec{ρ},\vec{H})≡\vec{S}ₙₘ(\vec{ρ})Zₖₗ(\vec{H})=\vec{S}ₙₘ(ρ,θ)Zₖₗ(H,ϕ) Eq. (35)

And the system ray error can be described as:

\vec{ε}(\vec{ρ},\vec{H})=ΣA_{nm,kl}\vec{S}_{nm,kl}(\vec{ρ},\vec{H}) Eq. (36)

where \vec{ε} can serve the same function as W (described above). The only step remaining is to express the decentered aberrations in terms of the vector polynomials \vec{S}. The rest of the technique can be the same as described above.

Induced Aberrations

Induced aberrations are aberration fields which are generated by pupil aberrations, which can often be excluded for 4th order optical design. Formulas exist up to 6th order for calculating the aberration field contributions including pupil aberrations. Nodal Aberration approach-like theory including pupil aberrations does not exist, however we can predict its characteristics. For example, just as the perturbations produce a field-displacement vector \vec{σ}, which generates decentered aberration fields, a pupil-displacement vector (\vec{ψ}) can be produced, which will also generate decentered aberration fields. Most terms may be linear in \vec{ψ}. The above-mentioned M₂ needs additional rows to list the ψ's as well as the σ's, and M₃ will be similarly modified. All other aspects can remain same.

Different Field-Weighting Dependencies

Some embodiments also assumed that the system metric was the image quality metric (e.g., RMS wavefront error or RMS spot size, as described above) rss'd over the field. The system metric can be characterized using any polynomial field-weighting, integrated over the field. If the system metric is generalized to include field-weighting, we get

$${W}_{sys} = {( \frac{{\int }_{field} {[ w ( \vec{H} ) {W}_{rms} ( \vec{H} ) ]}^{2} d \vec{H}}{{\int }_{field} d \vec{H}} )}^{1 / 2} \qquad Eq . ( 37 )$$

The field-weighting function can be expressed with Zernike polynomials:

$$w ( \vec{H} ) = {\sum }_{p , q} {a}_{pq} {\hat{Z}}_{pq} ( \vec{H} )$$

And using equation 39,

Z_{nm,kl}(\vec{ρ},\vec{H})≡Zₙₘ(\vec{ρ})Zₖₗ(\vec{H})=Zₙₘ(ρ,θ)Zₖₗ(H, ϕ) Eq. (39)

the expression in brackets in equation 35 becomes:

$$\begin{matrix}[ ] = ( {\sum }_{p , q} {a}_{pq} {\hat{Z}}_{pq} ( \vec{H} ) ) ( {\sum }_{n , m , k , l} {A}_{nm , kl} {\hat{Z}}_{nm , kl} ( \vec{ρ} , \vec{H} ) ) \\ = ( {\sum }_{p , q} {a}_{pq} {\hat{Z}}_{pq} ( \vec{H} ) ) ( {\sum }_{n , m , k , l} {A}_{nm , kl} {\hat{Z}}_{nm} ( \vec{ρ} ) {\hat{Z}}_{kl} ( \vec{H} ) )\end{matrix} \qquad Eq . ( 40 )$$

Since products of Zernike terms are also Zernike polynomials, this expression can put in terms of double Zernikes with different coefficients. Therefore, the approach disclosed in this patent document can be applied to image quality metrics with field-weighting.

An image quality metric can also be formed from a function of Wrms:

$${W}_{sys} = \frac{{\int }_{field} f ( {W}_{rms} ( \vec{H} ) ) d \vec{H}}{{\int }_{field} d \vec{H}} \qquad Eq . ( 41 )$$

Similarly, as long as f(·) is a polynomial, Wsys can be expressed in terms of double Zernikes, and the same approach can be applied as described in this document.

In some embodiments, a computer program (also known as a program, software, software application, script, or code) can be written in any form of programming language, including compiled or interpreted languages, and it can be deployed in any form, including as a stand alone program or as a module, component, subroutine, or other unit suitable for use in a computing environment to carry out at least some of the disclosed operations. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be stored on a tangible and non-transitory computer readable medium and deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method of determining an optical system configuration, the method comprising:
modifying a parameter associated with one of a shape, a position or a material of a first optical surface or optical component in an optical system that includes a plurality of optical surfaces or optical components, the optical system, prior to said modifying, having an associated nominal optical performance metric value;
tracing a first set of rays through the optical system;
(a) introducing a perturbation to the optical system to form a perturbed optical system, the perturbation representing a change in tolerance value associated with one of the optical surfaces or components of the optical system;
(b) computing a revised optical performance metric value associated with the perturbed optical system, the revised optical performance metric value computed based on double Zernike polynomials or double Zernike coefficients and providing a measure of optical performance after propagation of the first set of rays through the plurality of optical surfaces or optical components of the perturbed optical system;
(c) repeating operations (a) and (b) for a predetermined number of perturbations to collect a first set of revised optical performance metric values associated with a plurality of perturbations imparted to the optical system; and
(d) determining from the first set of revised optical performance metric values and the nominal optical performance metric value a particular optical system configuration that produces an optical performance metric that meets or improves upon a particular optical performance characteristic.

2. The method of claim 1, wherein the particular optical performance characteristic corresponds to the system configuration that produces the lowest valued optical performance metric from the first set of revised optical performance metric values and the nominal optical performance metric value.

3. The method of claim 1, wherein the computing the nominal or the revised optical performance metric values comprises:
computing pupil Zernike coefficients and field Zernike coefficients of a wavefront at each optical surface or optical component of the optical system; and
computing the nominal or the revised optical performance metric values based on a product of the pupil and field Zernike coefficients associated with the wavefront at each optical surface or optical component.

4. The method of claim 3, wherein the nominal optical performance metric value is computed based the following relationship:
MF₀²=ΣA_{nm,lk}²
wherein MF₀ is the nominal optical performance metric value, and A_{nm,ik} are double Zernike coefficients; and
wherein each of the revised optical performance metric values is computed based on the following relationship:
MF²=Σ(A_{nm,lk}+ΔA_{nm,lk})²
wherein MF is the revised optical performance metric value, A_{nm,lk} are double Zernike coefficients, and ΔA_{nm,lk} is a change in the double Zernike coefficients.

5. The method of claim 1, further comprising:
adding one or more compensators into the optical system to compensate at least in-part for wavefront aberrations introduced by one or more of the optical surfaces or optical components, and
determining the revised optical performance metric values for the optical system including the one or more compensators.

6. The method of claim 5, wherein determining the revised optical performance metric values comprises:
computing a residual value, Rᵢⱼ, that represents an effect of the one or more compensators on the optical system perturbed with a tolerance value; and
computing each of the revised optical performance metric values as a compensated merit function based on the following relationship:
MF²=MF₀²+ΣRᵢⱼ²
wherein MF is the revised optical performance metric value, MF₀ is the nominal optical performance metric value, Rᵢⱼ is the residual value, index i is a residual double Zernike coefficient, and index j is the tolerance value.

7. The method of claim 6, wherein R is computed as:
R=T−Ĉ′Ĉ′^{T}T
wherein T is a tolerance column vector of the double Zernike coefficients, Ĉ′^{T} is a transpose of Ĉ′, and Ĉ′ is a set of orthogonal unit compensation vectors of a matrix comprising a number of Zernike polynomials by a number of orthogonal unit compensators.

8. The method of claim 1, wherein introducing a perturbation to the optical system includes introducing a change indicative of a tolerance value associated with the first optical surface or optical component.

9. The method of claim 8, wherein the double Zernike polynomials or double Zernike coefficients are computed based at least on the following operations:
decentering the first optical surface or component by the tolerance value;
perturbing a gut ray associated with the first optical surface or component and each additional optical surface or component that the perturbed gut ray passes through; and
generating, for each optical surface or component that the perturbed gut ray passes through, a set of double Zernike polynomials or coefficients.

10. The method of claim 9, wherein computing each of the revised optical performance metric values comprises adding the set of double Zernike polynomials or coefficients.

11. The method of claim 10, wherein adding of the set of double Zernike polynomials or coefficients comprises a matrix multiplication to obtain a matrix comprising a number of Zernike polynomials by a number of tolerances.

12. The method of claim 1, further comprising:
prior to operation (d),
further modifying the parameter associated with one of a shape, a position or a material of the first optical surface or optical component;
(e) introducing another perturbation to the optical system;
(f) tracing a second set of rays through the optical system;
(g) computing a revised optical performance metric value associated with the perturbed optical system subsequent to the perturbation, the revised optical performance metric value computed based on double Zernike polynomials or double Zernike coefficients and providing a measure of optical performance after propagation of the second set of rays through the plurality of optical surfaces or optical components of the perturbed optical system subsequent to the perturbation associated with the second of the plurality of optical surfaces or optical components;
(h) repeating operations (e), (f) and (g) for a second predetermined number of perturbations to collect a second set of revised optical performance metric values; and wherein:
operation (d) comprises determining from the first set of revised optical performance metric values, the second set of revised optical performance values and the nominal optical performance metric value the particular optical system configuration that produces the optical performance metric that meets or exceeds the particular optical performance characteristic.

13. The method of claim 1, further comprising:
prior to operation (d), introducing additional perturbations to the optical system by changing parameters associated with one or more of shapes, positions or materials of the remaining optical surfaces or optical components in the optical system;
computing additional set of sets of revised optical performance metric associated with additional perturbations, and wherein operation (d) comprises determining from nominal optical performance value, and the first and the additional sets of revised optical performance metric values, the particular optical system configuration that produces the optical performance metric that meets or exceeds the particular optical performance characteristic.

14. The method of claim 13, further comprising:
selecting the particular optical system configuration that produces the optical performance metric that meets or exceeds the particular optical performance characteristic as the system configuration that produces lowest valued optical performance metric from the first set of revised optical performance metric values, the additional sets of revise optical performance metric values and the nominal optical performance metric value.

15. The method of claim 1, further comprising:
prior to operation (c),
restoring the perturbed optical system to the optical system prior to the introduction of the perturbation.

16. The method of claim 1, wherein the revised optical performance metric value that is computed based on double Zernike polynomials or double Zernike coefficients is obtained using two rays that are perturbed for the plurality of optical surfaces or optical components.

17. The method of claim 16, wherein a first of the two rays is a gut ray, and the second of the two rays is one of a paraxial ray or a non-paraxial ray.

18. The method of claim 1, wherein the revised optical performance metric value that is computed based on double Zernike polynomials or double Zernike coefficients is obtained without performing additional large-scale ray tracing operations.

19. The method of claim 1, wherein the double Zernike polynomials or double Zernike coefficients include polynomials or coefficients associated with a chromatic aberration.

20. A device, comprising: one or more processors; and
a memory including processor-executable instructions stored thereon, the processor-executable instructions upon execution by the one or more processors configures the device to:
modify a parameter associated with one of a shape, a position or a material of a first optical surface or optical component in an optical system that includes a plurality of optical surfaces or optical components, the optical system, prior to said modifying, having an associated nominal optical performance metric value;
trace a first set of rays through the optical system;
(a) introduce a perturbation to the optical system to form a perturbed optical system, the perturbation representing a change in tolerance value associated with one of the optical surfaces or components of the optical system;
(b) compute a revised optical performance metric value associated with the perturbed optical system, the revised optical performance metric value computed based on double Zernike polynomials or double Zernike coefficients and providing a measure of optical performance after propagation of the first set of rays through the plurality of optical surfaces or optical components of the perturbed optical system;
(c) repeat operations (a) and (b) for a predetermined number of perturbations to collect a first set of revised optical performance metric values associated with a plurality of perturbations imparted to the optical system; and
(d) determine from the first set of revised optical performance metric values and the nominal optical performance metric value a particular optical system configuration that produces an optical performance metric that meets or improves upon a particular optical performance characteristic.

21. The device of claim 20, wherein the particular optical performance characteristic corresponds to the system configuration that produces the lowest valued optical performance metric from the first set of revised optical performance metric values and the nominal optical performance metric value.

22. The device of claim 20, wherein the processor-executable instructions upon execution by the processor configures the device to compute the nominal or the revised optical performance metric values by:
computing pupil Zernike coefficients and field Zernike coefficients of a wavefront at each optical surface or optical component of the optical system; and
computing the nominal or the revised optical performance metric values based on a product of the pupil and field Zernike coefficients associated with the wavefront at each optical surface or optical component.

23. The device of claim 22, wherein the nominal optical performance metric value is computed based the following relationship:
MF₀²=ΣA_{nm,lk}²
wherein MF₀ is the nominal optical performance metric value, and A_{nm,lk} are double Zernike coefficients; and
wherein each of the revised optical performance metric values is computed based on the following relationship:
MF²=Σ(A_{nm,lk}+ΔA_{nm,lk})²
wherein MF is the revised optical performance metric value, A_{nm,lk} are double Zernike coefficients, and ΔA_{nm,lk} is a change in the double Zernike coefficients.

24. The device of claim 20, wherein the processor-executable instructions upon execution by the processor further configures the device to:
add one or more compensators into the optical system to compensate at least in-part for wavefront aberrations introduced by one or more of the optical surfaces or optical components, and
determine the revised optical performance metric values for the optical system including the one or more compensators.

25. The device of claim 24, wherein the revised optical performance metric values are computed by:
computing a residual value, Rᵢⱼ, that represents an effect of the one or more compensators on the optical system perturbed with a tolerance value; and
computing each of the revised optical performance metric values as a compensated merit function based on the following relationship:
MF²=MF₀²+ΣRᵢⱼ²
wherein MF is the revised optical performance metric value, MF₀ is the nominal optical performance metric value, Rᵢⱼ is the residual value, index i is a residual double Zernike coefficient, and index j is the tolerance value.

26. The device of claim 25, wherein R is computed as:
R=T−Ĉ′Ĉ′^{T}T
wherein T is a tolerance column vector of the double Zernike coefficients, Ĉ′^{T} is a transpose of Ĉ′, and Ĉ′ is a set of orthogonal unit compensation vectors of a matrix comprising a number of Zernike polynomials by a number of orthogonal unit compensators.

27. The device of claim 20, wherein introduction of the perturbation to the optical system includes introduction of a change indicative of a tolerance value associated with the first optical surface or optical component.

28. The device of claim 27, wherein the processor-executable instructions upon execution by the processor configures the device to compute the double Zernike polynomials or double Zernike coefficients by:
decentering the first optical surface or component by the tolerance value;
perturbing a gut ray associated with the first optical surface or component and each additional optical surface or component that the perturbed gut ray passes through; and
generating, for each optical surface or component that the perturbed gut ray passes through, a set of double Zernike polynomials or coefficients.

29. The system of claim 28, wherein computation of each of the revised optical performance metric values comprises addition of the set of double Zernike polynomials or coefficients.

30. The device of claim 29, wherein the addition of the set of double Zernike polynomials or coefficients comprises a matrix multiplication to obtain a matrix comprising a number of Zernike polynomials by a number of tolerances.

31. The device of claim 20, wherein the processor-executable instructions upon execution by the processor further configures the device to:
prior to operation (d),
further modify the parameter associated with one of a shape, a position or a material of the first optical surface or optical component;
(e) introduce another perturbation to the optical system;
(f) trace a second set of rays through the optical system;
(g) compute a revised optical performance metric value associated with the perturbed optical system subsequent to the perturbation, the revised optical performance metric value computed based on double Zernike polynomials or double Zernike coefficients and providing a measure of optical performance after propagation of the second set of rays through the plurality of optical surfaces or optical components of the perturbed optical system subsequent to the perturbation associated with the second of the plurality of optical surfaces or optical components;
(h) repeat operations (e), (f) and (g) for a second predetermined number of perturbations to collect a second set of revised optical performance metric values; and wherein:
operation (d) comprises a determination from the first set of revised optical performance metric values, the second set of revised optical performance values and the nominal optical performance metric value the particular optical system configuration that produces the optical performance metric that meets or exceeds the particular optical performance characteristic.

32. The device of claim 20, wherein the processor-executable instructions upon execution by the processor further configures the device:
prior to operation (d), introduce additional perturbations to the optical system by changing parameters associated with one or more of shapes, positions or materials of the remaining optical surfaces or optical components in the optical system;
compute additional set of sets of revised optical performance metric associated with additional perturbations, and
as part of operation (d) determine from nominal optical performance value, and the first and the additional sets of revised optical performance metric values, the particular optical system configuration that produces the optical performance metric that meets or exceeds the particular optical performance characteristic.

33. The device of claim 32, wherein the processor-executable instructions upon execution by the processor configures the device to:
select the particular optical system configuration that produces the optical performance metric that meets or exceeds the particular optical performance characteristic as the system configuration that produces lowest valued optical performance metric from the first set of revised optical performance metric values, the additional sets of revise optical performance metric values and the nominal optical performance metric value.

34. The device of claim 20, further comprising:
prior to operation (c),
restore the perturbed optical system to the optical system prior to the introduction of the perturbation.

35. The device of claim 20, wherein the revised optical performance metric value that is computed based on double Zernike polynomials or double Zernike coefficients is obtained using two rays that are perturbed for the plurality of optical surfaces or optical components.

36. The device of claim 35, wherein a first of the two rays is a gut ray, and the second of the two rays is one of a paraxial ray or a non-paraxial ray.

37. The device of claim 20, wherein the revised optical performance metric value that is computed based on double Zernike polynomials or double Zernike coefficients is obtained without performing additional large-scale ray tracing operations.

38. The device of claim 20, wherein the double Zernike polynomials or double Zernike coefficients include polynomials or coefficients associated with a chromatic aberration.

39. A computer program product comprising a non-transitory computer-readable medium having a program code stored thereon that is executable by a processor, the computer program product comprising:
program code for modifying a parameter associated with one of a shape, a position or a material of a first optical surface or optical component in an optical system that includes a plurality of optical surfaces or optical components, the optical system, prior to said modifying, having an associated nominal optical performance metric value;
program code for tracing a first set of rays through the optical system;
(a) program code for introducing a perturbation to the optical system to form a perturbed optical system, the perturbation representing a change in tolerance value associated with one of the optical surfaces or components of the optical system;
(b) program code for computing a revised optical performance metric value associated with the perturbed optical system, the revised optical performance metric value computed based on double Zernike polynomials or double Zernike coefficients and providing a measure of optical performance after propagation of the first set of rays through the plurality of optical surfaces or optical components of the perturbed optical system;
(c) program code for repeating program codes for (a) and (b) for a predetermined number of perturbations to collect a first set of revised optical performance metric values associated with a plurality of perturbations imparted to the optical system; and
(d) program code for determining from the first set of revised optical performance metric values and the nominal optical performance metric value a particular optical system configuration that produces an optical performance metric that meets or improves upon a particular optical performance characteristic.
